(19) United States
(12) Patent Application Publication
(10) Pub. No.: US 2026/0331392 A1
(43) Pub. Date: Oct. 22, 2026

(54) SWITCHING DEVICE

(71) Applicant: XIAMEN HONGFA ELECTRIC POWER CONTROLS CO., LTD., Xiamen, Fujian (CN)

(72) Inventors: Wenguang DAI, Xiamen, Fujian (CN); Shuming ZHONG, Xiamen, Fujian (CN); Fangneng LI, Xiamen, Fujian (CN); Jianxin HU, Xiamen, Fujian (CN)

(21) Appl. No.: 19/583,009

(22) PCT Filed: Oct. 25, 2024
(86) PCT No.: PCT/CN2024/127409

§ 371 Date: Apr. 29, 2026

(30) Foreign Application Priority Data
Nov. 1, 2023 (CN) 202322961719.9

(51) Int. Cl. H01H 9/36; H01H 9/44; H01H 50/54; H01H 50/56

(52) U.S. Cl. CPC H01H 9/36; H01H 9/443; H01H 50/541; H01H 50/56

(57) ABSTRACT

The present application provides a switching device, including a contact system. The contact system includes two contact sets, where the two contact sets comprise an arc resistant end contact set and a current carrying end contact set, and each of the two contact sets comprises at least one pair of movable and stationary contacts; when the contact system is disconnected, a gap between the movable and stationary contacts of the arc resistant end contact set is less than a gap between the movable and stationary contacts of the current carrying end contact set, wherein a periphery of the arc resistant end contact set is provided with a permanent magnet.

### CROSS-REFERENCE TO RELATED APPLICATIONS

The present application is a national stage entry under 35 U.S.C. § 371 of International Application No. PCT/CN2024/127409, filed Oct. 25, 2024, which claims priority to Chinese Patent Application No. 202322961719.9, filed Nov. 1, 2023, the entire disclosures of which are hereby incorporated herein by reference.

### TECHNICAL FIELD

The present application relates to the field of switching devices, and in particular to a magnetic latching relay.

### BACKGROUND

As an electronic control device, a relay is used to control a large current using a small current. The relay is widely applied in automatic control circuits, and plays a role in automatic adjustment, safety protection and conversion circuit in the circuits. A magnetic latching relay, as a kind of relay, is characterized in that open or closed states of contacts are latched by a permanent magnet. When the relay is applied to an alternating current (sine wave) loop, since a zero-crossing switching technology can be adopted, requirements for arc extinguishing capacity of an electromagnetic relay are relatively lower. However, when the relay is applied to a direct current loop, and when the relay withstands a short-circuit current or suffers a lightning strike, if an action of the relay makes the contacts open, an arc in an existing relay product is easy to directly hit plastic parts of a base or an outer cover, and the base or a push card is easy to melt, and the arc resistance strength is low, causing serious damage to a structure of the relay and unnecessary loss. Therefore, when the relay withstands a large direct current load, the industry has always been chasing after better improvement of the arc extinguishing capacity of the electromagnetic relay to make the electromagnetic relay better suitable for high direct current and high direct voltage occasions.

There are also some technical solutions in which direct current load relays are connected in a connection manner with specified polarities, that is, the contacts have the polarities. If the polarities are connected by mistake, the performance of the relay will be greatly reduced, making the electrical life of the relay will be greatly shortened, and even make the relay unable to work normally.

### SUMMARY

Therefore, in view of the above problems, the present application provides a switching device.

The present application is achieved by adopting the following solutions:

The present application provides a switching device, including a contact system, wherein the contact system includes two contact sets, wherein the two contact sets include an arc resistant end contact set and a current carrying end contact set, and each of the two contact sets includes at least one pair of movable and stationary contacts; when the contact system is disconnected, a gap between the movable and stationary contacts of the arc resistant end contact set is less than a gap between the movable and stationary contacts of the current carrying end contact set, wherein a periphery of the arc resistant end contact set is provided with a permanent magnet.

In one embodiment, the arc resistant end contact set includes a first movable contact and a second stationary contact, the current carrying end contact set includes a first stationary contact and a second movable contact, and the contact system further includes a first movable spring and a second movable spring, wherein the first stationary contact and the first movable contact are respectively arranged at both ends of the first movable spring in a length direction, the second stationary contact and the second movable contact are respectively arranged at both ends of the second movable spring in a length direction, the first stationary contact and the second movable contact are oppositely arranged, and the first movable contact and the second stationary contact are oppositely arranged.

In one embodiment, the switching device further includes a base, wherein the contact system is mounted on the base, a direction close to the base is defined as below, a direction away from the base is defined as above, ceramic pieces are further arranged above and below the arc resistant end contact set, and the permanent magnet is arranged at a side of the arc resistant end contact set so that the permanent magnet is located at the periphery of the arc resistant end contact set.

In one embodiment, the switching device further includes a base, wherein the contact system is mounted on the base, a direction close to the base is defined as below, a direction away from the base is defined as above, ceramic pieces are further arranged above and below the arc resistant end contact set, and the permanent magnet is arranged at a side of the arc resistant end contact set so that the permanent magnet is located at the periphery of the arc resistant end contact set; each of the ceramic pieces includes a first portion and a second portion connected to each other, the first portion and the second portion are perpendicular to each other, the first portion is sheet-shaped, the second portion is plate-shaped with thin in the middle and thick at both sides, a portion which is thin in the middle is provided with a notch which is arc-shaped, and a diameter of the notch is greater than a diameter of contacts of the arc resistant end contact set, so that after the ceramic pieces are mounted, the second portion is at least partially located between the first movable spring and the second movable spring, and the notch is exactly opposite the contacts and at least partially arranged around the contacts.

In one embodiment, the switching device further includes a base, wherein the contact system is mounted on the base, a direction close to the base is defined as below, a direction away from the base is defined as above, arc extinguishing grids are further arranged above and below the arc resistant end contact set, and the permanent magnet is arranged at a side of the arc resistant end contact set so that the permanent magnet is located at the periphery of the arc resistant end contact set.

In one embodiment, each of the arc extinguishing grids includes a grid base, one or more arc extinguishing grid pieces and an arc striking grid piece, wherein the grid base is provided with a plurality of slots parallel to each other, and the arc extinguishing grid pieces and the arc striking grid piece are inserted into the slots, so that each of the arc extinguishing grid pieces and the arc striking grid piece are arranged parallel to each other.

In one embodiment, a quantity of the arc extinguishing grid pieces is two or more, the arc extinguishing grid pieces have equal lengths and aligned ends, an end of the arc extinguishing grid piece is provided with an arc extinguishing notch, and an end of the arc striking grid piece is provided with an arc striking flap piece which exceeds the end of the arc extinguishing grid piece and bends obliquely to a direction of the contact sets.

In one embodiment, the switching device further includes a case, wherein the arc extinguishing grids arranged above and below the arc resistant end contact set are respectively mounted on the case and the base.

In one embodiment, the switching device further includes a base, wherein the contact system is mounted on the base, a direction close to the base is defined as below, a direction away from the base is defined as above, the permanent magnet is arranged above the arc resistant end contact set so that the permanent magnet is located at the periphery of the arc resistant end contact set, and ceramic pieces are arranged at least in left and right directions of the arc resistant end contact set.

In one embodiment, the permanent magnet is only arranged at the periphery of the arc resistant end contact set, and not arranged at a periphery of the current carrying end contact set.

In one embodiment, the switching device is a magnetic latching relay.

The technical solutions provided by the present application have the following technical effects.
1. In the present application, the permanent magnet is arranged at one side of the arc resistant end contact set consisting of the first movable contact and the second stationary contact. The permanent magnet is arranged at one side of the contact sets, and when a relay switches a direct current to disconnected, the arc will be lengthened and extinguished by using an action of a force that the current withstands in a magnetic field, thereby playing a role of magnetic blowing to extinguish the arc. Moreover, the permanent magnet is arranged at one side of the arc resistant end contact set, so that the contact system designed as an anti-short circuit structure of a double-contact parallel circuit can achieve a technical effect of magnetic blowing to extinguish the arc on the basis of being able to carry a large current without arranging the permanent magnet at one side of each contact set of the double contact sets, thereby simplifying a structure of the relay, saving raw materials and making a layout of the relay more compact. Moreover, a distance between the arc resistant end contact set and the current carrying end contact set can be widened, thereby avoiding the arc generated by the arc resistant end contact set from polluting the current carrying end contact set, and prolonging the service life of the product. In addition, the permanent magnet is arranged at one side of the contact sets, thereby realizing non-polarized load wiring.
2. In the present application, the ceramic pieces are further arranged above and below the arc resistant end contact set. On the one hand, the ceramic pieces can prevent the arc from burning, for example, a plastic case, and on the other hand, the ceramic pieces also have a cooling effect on the arc, thereby being more conducive to disconnection of the arc.
3. In the present application, the arc extinguishing grids are further optionally arranged above and below the arc resistant end contact set, and the arc extinguishing grids can play a role of greatly enhancing an arc extinguishing effect on the basis that the permanent magnet achieves an effect of magnetic blowing to extinguish the arc.

### BRIEF DESCRIPTION OF THE DRAWINGS

FIG. 1 is a perspective view of a magnetic latching relay.

FIG. 2 is a perspective view of a magnetic latching relay in a direction of a base.

FIG. 3 is a front view of a magnetic latching relay with a case removed.

FIG. 4 is a front view of the magnetic latching relay with a case and a base removed.

FIG. 5 is a front view of a magnetic circuit system and a contact system in an open state.

FIG. 6 is a cross-sectional view of a contact system.

FIG. 7 is a perspective view of an installation of a base and a ceramic piece.

FIG. 8 is a perspective view of a base.

FIG. 9 is a perspective view of a ceramic piece.

FIG. 10 is a perspective view of a permanent magnet bracket.

FIG. 11 is a perspective view of a case.

FIG. 12 is a front view of a magnetic latching relay with a permanent magnet located above and a case removed.

FIG. 13 is a cross-sectional view of a contact system with a permanent magnet located above.

FIG. 14 is a perspective view of a case according to another embodiment.

FIG. 15 is a perspective view of an installation of a base and a ceramic piece according to another embodiment.

FIG. 16 is a perspective view of a ceramic piece according to another embodiment.

FIG. 17 is a perspective view of arc extinguishing grids arranged above and below contacts.

FIG. 18 is a perspective view of a contact system and a magnetic circuit system with arc extinguishing grids arranged above and below contacts.

FIG. 19 is a perspective view of an arc extinguishing grid.

FIG. 20 is a perspective view of a grid base.

FIG. 21 is a perspective view of an installation of an arc extinguishing grid and a case.

FIG. 22 is a perspective view of a case according to another embodiment.

FIG. 23 is a perspective view of an installation of an arc extinguishing grid and a base.

FIG. 24 is a perspective view of a base according to another embodiment.

### DETAILED DESCRIPTION OF THE EMBODIMENTS

In order to further illustrate various embodiments, the present application provides accompanying drawings. These accompanying drawings, which constitute a part of the disclosed contents of the present application, are mainly used for illustrating the embodiments and explaining the operation principles of the embodiments together with the related description of the specification. Other possible embodiments and advantages of the present application will be understood by those skilled in the art with reference to these contents. Components in the drawings are not drawn to scale, and similar reference numerals of components are generally used to represent similar components.

The present application will now be further described in conjunction with the accompanying drawings and specific embodiments.

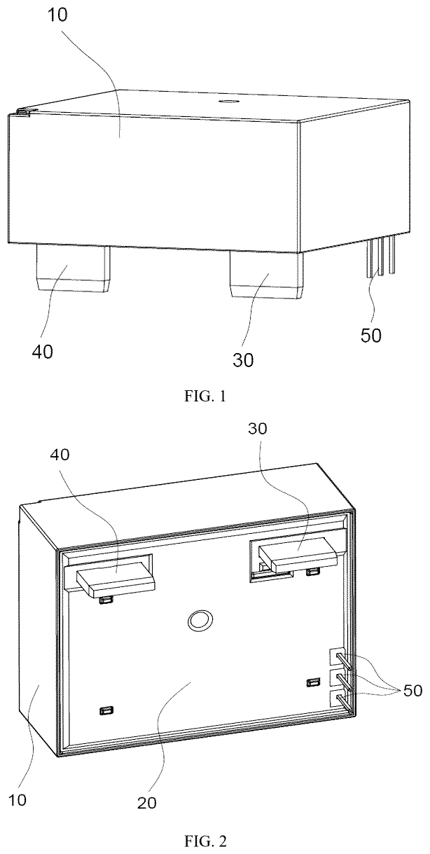

As shown in FIG. 1 to FIG. 6, the present application provides a magnetic latching relay, including a base 20, a case 10, a first lead-out pin 30, a second lead-out pin 40, a coil lead-out pin 50, a magnetic circuit system 60 and a contact system 70. In this embodiment, the first lead-out pin 30 and the second lead-out pin 40 are sheet-shaped. The contact system 70 is connected to the first lead-out pin 30 and the second lead-out pin 40. The magnetic circuit system 60 is used to actuate the contact system 70, so that movable and stationary contacts in the contact system 70 are closed or opened, thereby making the first lead-out pin 30 and the second lead-out pin 40 conducted or disconnected. The magnetic circuit system 60 is connected to the coil lead-out pin 50, and the coil lead-out pin 50 is used to connect a control circuit, so as to control the actuation of the magnetic circuit system 60 to the contact system 70. The magnetic circuit system 60 and the contact system 70 are mounted on the base 20. The case 10 is fitted to the base 20 to form an internal space in the case 10 and the base 20, and the magnetic circuit system 60 and the contact system 70 are cladded in the internal space by the case 10 and the base 20. The first lead-out pin 30, the second lead-out pin 40 and the coil lead-out pin 50 pass through a bottom surface of the base 20 to extend downwards out of the internal space.

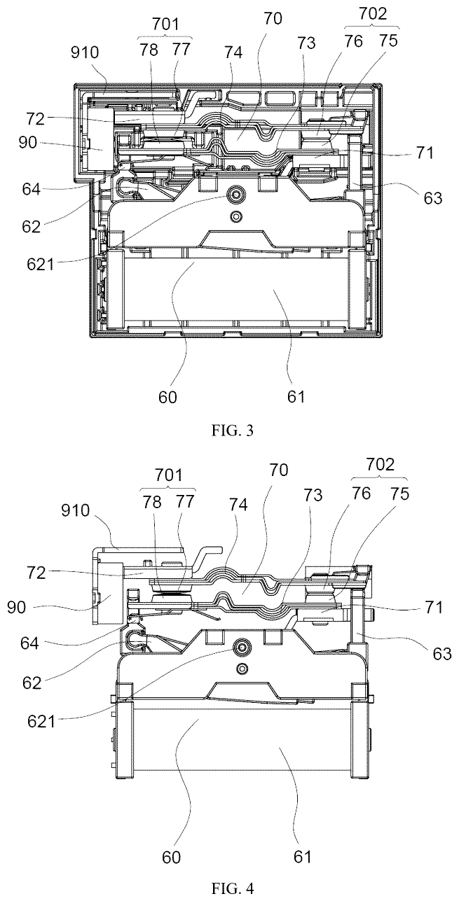

As shown in FIG. 3, the contact system 70 adopts a double-contact anti-short circuit structure. Specifically, the contact system 70 includes a first lead-out piece 71, a first movable spring 73, a second lead-out piece 72, a second movable spring 74, an arc resistant end contact set 701, and a current carrying end contact set 702. Each of the arc resistant end contact set 701 and the current carrying end contact set 702 includes at least one pair of movable and stationary contacts. In this embodiment, the arc resistant end contact set 701 includes a first movable contact 78 and a second stationary contact 77, and the current carrying end contact set 702 includes a first stationary contact 75 and a second movable contact 76. As shown in FIG. 5, when the contact system 70 is disconnected, a gap S1 between the first movable contact 78 and the second stationary contact 77 is less than a gap S2 between the first stationary contact 75 and the second movable contact 76, that is, S1<S2.

In the contact system 70 of this embodiment, the first movable spring 73 is connected to the first lead-out piece 71, and the second movable spring 74 is connected to the second lead-out piece 72. The first stationary contact 75 and the first movable contact 78 are respectively arranged at two ends of the first movable spring 73 in a length direction, and the second stationary contact 77 and the second movable contact 76 are respectively arranged at two ends of the second movable spring 74 in a length direction, so that the first stationary contact 75 and the second movable contact 76 are arranged opposite to each other, and the first movable contact 78 and the second stationary contact 77 are arranged opposite to each other.

It will be understood that in the contact system 70 of the embodiment of the present application, since contact gaps between the two movable and stationary contact sets are different in an open state, in the process of switching the contact system 70 from a closed state to the open state, the first stationary contact 75 and the second movable contact 76 in the contact set with the relatively large contact gap will be disconnected prior to the first movable contact 78 and the second stationary contact 77 in the contact set with the relatively small contact gap, and when the first stationary contact 75 and the second movable contact 76 in the contact set with the relatively large contact gap have just been disconnected, the first movable contact 78 and the second stationary contact 77 in the contact set with the relatively small contact gap have not been completely disconnected, and thus the first stationary contact 75 and the second movable contact 76 in the contact set with the relatively large contact gap will not generate an arc during disconnection. Therefore, the first stationary contact 75 and the second movable contact 76 in the contact set with the relatively large contact gap plays a role of current carrying, while the first movable contact 78 and the second stationary contact 77 in the contact set with the relatively small contact gap plays a role of arc resistance.

It should be added that the contact gaps between the two movable and stationary contact sets are designed to be different and can be achieved by reducing a contact height. Specifically, as shown in FIG. 5, contact thicknesses of the first stationary contact 75 and the second movable contact 76 are less than contact thicknesses of the first movable contact 78 and the second stationary contact 77, and when the contact system 70 is in the open state, since the contact thicknesses of the first stationary contact 75 and the second movable contact 76 are less than the contact thicknesses of the first movable contact 78 and the second stationary contact 77, the contact gap between the first stationary contact 75 and the second movable contact 76 is relatively large and larger than the contact gap between the first movable contact 78 and the second stationary contact 77.

In addition, the contact gaps between the two movable and stationary contact sets are designed to be different and can also be achieved by tilting at least one of the first movable spring 73 or the second movable spring 74.

Apparently, the contact gaps can also be designed to be different in other ways, which will not be enumerated herein, as long as the contact gaps between the two movable and stationary contact sets are different when the contact system 70 is in the open state.

In the contact system 70, the first movable spring 73 and the second movable spring 74 are arranged in parallel, and the movable and stationary contacts on the first movable spring 73 and the second movable spring 74 correspond to each other to form two movable and stationary contact sets, so that the two movable and stationary contact sets, that is, the first movable contact 78 and the second stationary contact 77, as well as the first stationary contact 75 and the second movable contact 76, contact with each other to form a parallel circuit structure. The contact system 70 is designed as an anti-short circuit structure of a double-contact parallel circuit, thereby effectively reducing the temperature rise and improving the capacity of carrying large currents such as a short-circuit current or a lightning strike current.

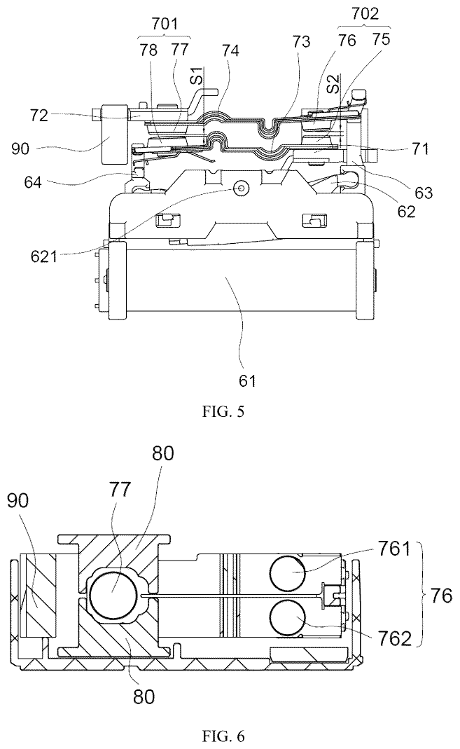

As shown in FIG. 6, in the current carrying end contact set 702, that is, the contact set of the first stationary contact 75 and the second movable contact 76, the first stationary contact 75 can be composed of a plurality of stationary sub-contacts, the second movable contact 76 can be composed of a plurality of movable sub-contacts, for example, a movable sub-contact 761 and a movable sub-contact 762, and the stationary sub-contacts and the movable sub-contacts form a plurality of contact sets correspondingly, so that the parallel structure formed by the plurality of contact sets can further reduce the temperature rise of the relay and further improve the current carrying capacity of the relay.

As shown in FIG. 4 and FIG. 5, a periphery of the arc resistant end contact set 701, that is, the contact set consisting of the first movable contact 78 and the second stationary contact 77, is provided with a permanent magnet 90. In this embodiment, the permanent magnet 90 is arranged at the periphery of the arc resistant end contact set, when a relay switches a direct current to disconnected, the arc will be lengthened and extinguished by using an action of a force that the current withstands in a magnetic field, thereby playing a role of magnetic blowing to extinguish the arc. Moreover, in this embodiment, the permanent magnet 90 is arranged at the periphery of the arc resistant end contact set 701 and is not arranged at the periphery of the current carrying end contact set 702, so that the contact system 70 designed as an anti-short circuit structure of a double-contact parallel circuit can achieve a technical effect of magnetic blowing to extinguish the arc on the basis of being able to carry a large current without arranging the permanent magnet at the periphery of each contact set of the double contact sets, thereby simplifying a structure of the relay, saving raw materials and making a layout of the relay more compact. Moreover, a distance between the arc resistant end contact set 701 and the current carrying end contact set 702 can be widened, thereby avoiding the arc generated by the arc resistant end contact set 701 from polluting the current carrying end contact set 702, and prolonging the service life of the product.

In addition, in this embodiment, the permanent magnet 90 is arranged at one side of the contact sets, thereby realizing non-polarized load wiring. For a connection manner of some direct current load relays, the polarities are specified, if the polarities are connected by mistake, the performance of the relay will be greatly reduced, and even make the relay unable to work normally.

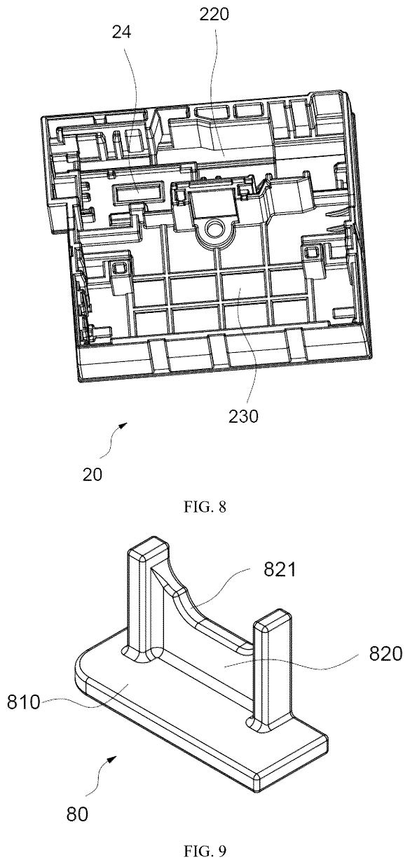

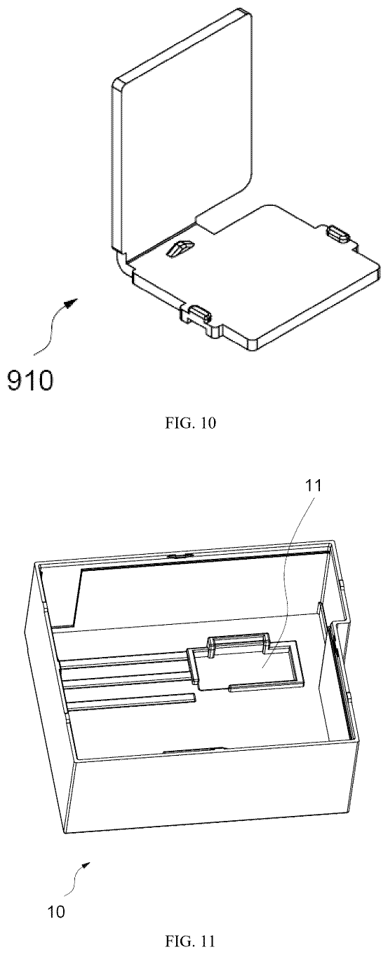

As shown in FIG. 2 to FIG. 8, the base 20 is provided with a first mounting groove 220 and a second mounting groove 230. The first mounting groove 220 is used for mounting the contact system 70, and the second mounting groove 230 is used for mounting the magnetic circuit system 60. The first mounting groove 220 and the second mounting groove 230 are arranged on the base 20 side by side. As shown in FIG. 3 to FIG. 5 and FIG. 10, the permanent magnet 90 can be mounted on a permanent magnet bracket 910, and the permanent magnet bracket 910 can be mounted on the base 20, so as to firmly mount the permanent magnet 90 on the base 20. The permanent magnet bracket 910 can be an L-shaped metal bracket. The permanent magnet bracket 910 is made of a permeability magnetic material such as iron. The permanent magnet bracket 910 adopting the permeability magnetic material can reduce magnetic leakage, thereby improving the magnetic efficiency of the permanent magnet 90, and being more conducive to the improvement of the effect of magnetic blowing to extinguish the arc.

It has been described above that the permanent magnet 90 is arranged at the periphery of the arc resistant end contact set 701, that is, the contact set consisting of the first movable contact 78 and the second stationary contact 77, so as to achieve the technical effect of magnetic blowing to extinguish the arc. On this basis, in order to further enhance the arc extinguishing effect, as shown in FIG. 6, ceramic pieces 80 are arranged above and below the arc resistant end contact set 701, that is, the contact set consisting of the first movable contact 78 and the second stationary contact 77. On the one hand, the ceramic pieces 80 can prevent the arc from burning, for example, a plastic case 10, and on the other hand, the ceramic pieces 80 also have a cooling effect on the arc, thereby being more conducive to disconnection of the arc.

In this structure, the permanent magnet 90 is arranged at a side of the arc resistant end contact set 701 so that the permanent magnet is located at the periphery of the arc resistant end contact set 701, as shown in FIG. 6. In other embodiments, the permanent magnet 90 can also be set to be replaced with two permanent magnet sets having opposite polarities at their inner ends.

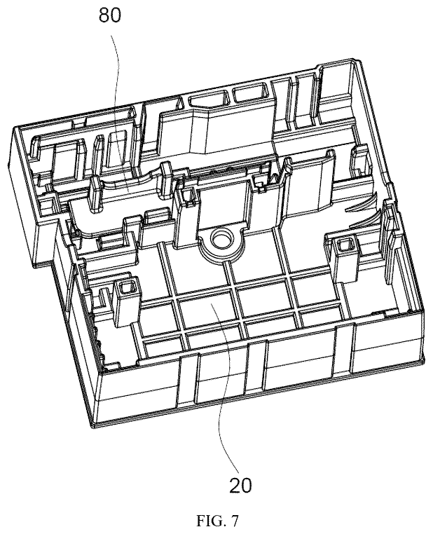

As shown in FIG. 6 to FIG. 9, the ceramic piece 80 includes a first portion 810 and a second portion 820 connected to each other. The first portion 810 and the second portion 820 are substantially perpendicular to each other, the first portion 810 is sheet-shaped, and the first portion 810 can be mounted on the base 20 or the case 10 as a base. Specifically, referring to FIG. 7 to FIG. 11, the base 20 is provided with a lower mounting groove 24, and the first portion 810 can be mounted in the lower mounting groove 24, so as to mount the ceramic piece 80 on the base 20. The case 10 is provided with an upper mounting groove 11, and the first portion 810 can be mounted in the upper mounting groove 11, so as to mount the ceramic piece 80 on the case 10. The second portion 820 is plate-shaped with thin in the middle and thick at both sides, a portion which is thin in the middle is provided with a notch 821 which is roughly arc-shaped, and a diameter of the notch 821 is greater than a diameter of contacts of the arc resistant end contact set 701, so that after the ceramic piece 80 is mounted, the second portion 820 is at least partially located between the first movable spring 73 and the second movable spring 74, and the notch 821 is exactly opposite the contacts and at least partially around the contacts. In this way, the upper and lower ceramic pieces 80 are arranged at least partially around the contacts of the arc resistant end contact set 701. Due to the insulating characteristics of the ceramic pieces 80, arcs between the contacts of the arc resistant end contact set 701 are easier to be disconnected, and the cooling effect on the arcs is improved.

In other embodiments, the ceramic piece 80 can also be replaced with other insulating and thermal insulation materials such as silica and mica, so as to form insulating and thermal insulation structures on two sides of the contacts. Since the ceramic piece 80 is low in cost and simple in manufacturing, the ceramic piece 80 is used as a specific embodied structure in this embodiment.

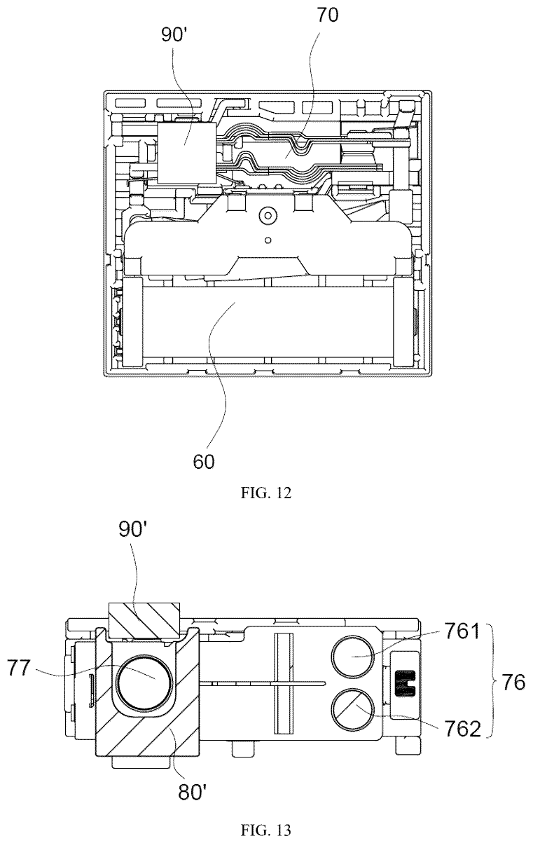

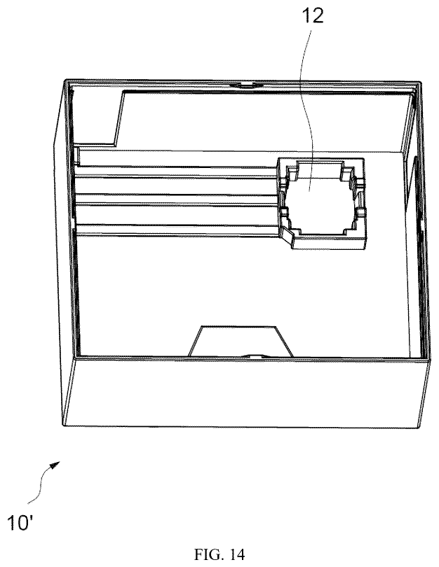

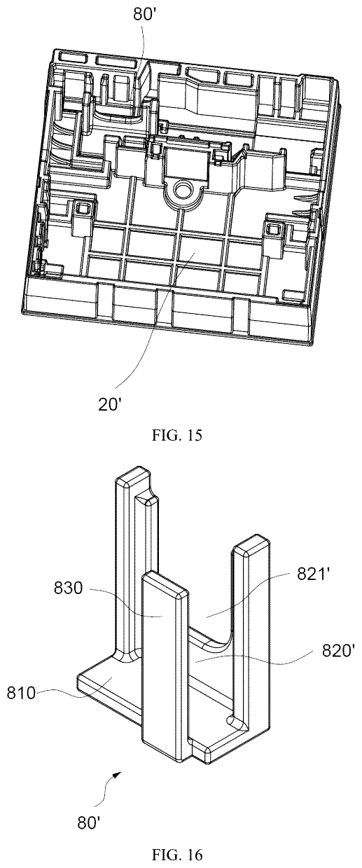

Optionally, as shown in FIG. 12 to FIG. 16, a direction close to the base 20 is defined as being below, a direction away from the base 20 is defined as being above, a permanent magnet 90′ can also be arranged above the arc resistant end contact set 701, that is, the contact set consisting of the first movable contact 78 and the second stationary contact 77, so that the permanent magnet is located at the periphery of the arc resistant end contact set 701. In this way, a ceramic piece 80′ is only arranged below the contact set. The ceramic piece 80′ is provided with a first portion 810 and a lengthened second portion 820′. The second portion 820′ is provided with a relatively deep notch 821′, so that the contacts can be substantially accommodated in the notches 821′ after the ceramic piece 80′ is mounted, and then the ceramic piece 80′ are arranged around the periphery of the arc resistant end contact set 701 in three directions, namely left, right and downward directions, of the arc resistant end contact set 701, as shown in FIG. 13. In other embodiments, the ceramic pieces are only arranged in the left and right directions of the arc resistant end contact set 701. When the permanent magnet 90′ is arranged above the arc resistant end contact set 701, directions that need arc extinguishing is the left and right directions of the arc resistant end contact set 701. The ceramic pieces are arranged at least in the left and right directions of the arc resistant end contact set 701, so that on the basis that the permanent magnet 90′ achieves the effect of magnetic blowing to extinguish the arc, the ceramic pieces can also have the cooling effect on the arc, thereby being conducive to the disconnection of the arc, using fewer ceramic pieces, saving raw materials and simplifying the structure. A positioning arm 830 is further connected to the first portion 810 of the ceramic piece 80′. The positioning arm 830 plays an auxiliary positioning role for mounting the ceramic piece 80′ on the base 20′. In this structure, a case 10′ is provided with a permanent magnet mounting groove 12, and the permanent magnet 90′ can be mounted in the permanent magnet mounting groove 12.

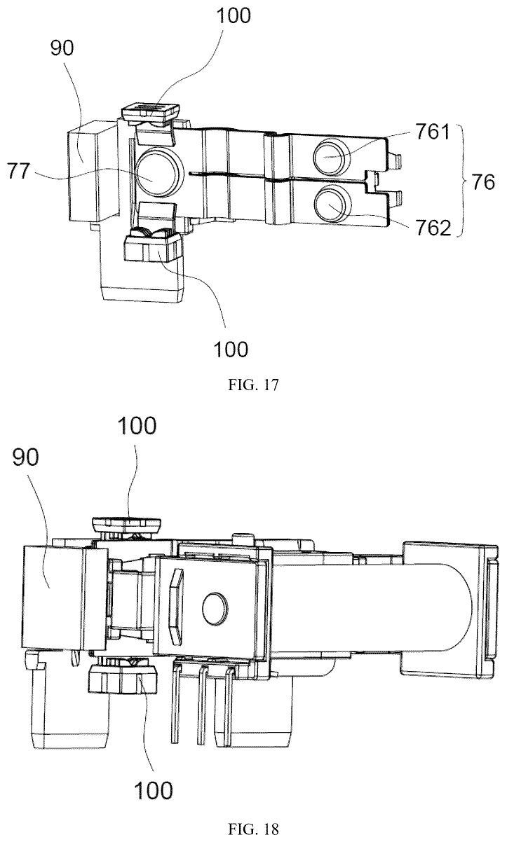

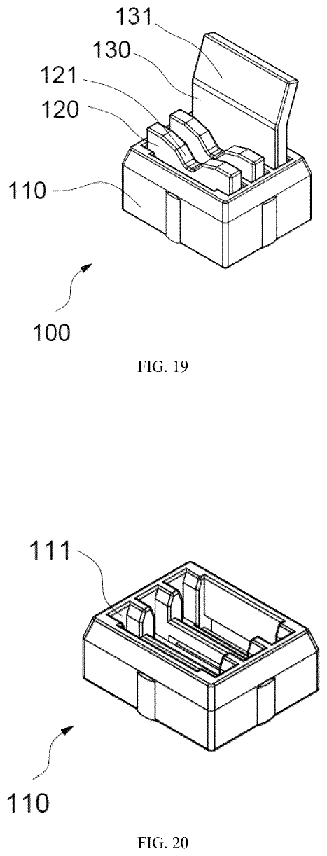

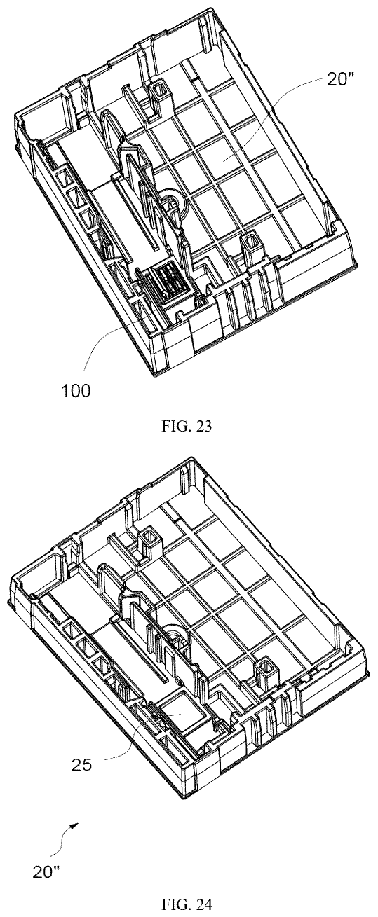

It has been described above that the permanent magnet 90 is arranged at one side of the arc resistant end contact set 701, that is, the contact set consisting of the first movable contact 78 and the second stationary contact 77, and the ceramic pieces 80 are arranged above and below the arc resistant end contact set 701, that is, the contact set consisting of the first movable contact 78 and the second stationary contact 77, so as to enhance the arc extinguishing effect. Alternatively, referring to FIG. 17 to FIG. 24, the ceramic pieces 80 are not arranged above and below the arc resistant end contact set 701, that is, the contact set consisting of the first movable contact 78 and the second stationary contact 77, while the ceramic pieces 80 are replaced with arc extinguishing grids 100. That is, the arc extinguishing grids 100 are arranged above and below the arc resistant end contact set 701, that is, the contact set consisting of the first movable contact 78 and the second stationary contact 77. The arrangement of the arc extinguishing grids 100 can play a role of greatly enhancing the arc extinguishing effect on the basis that the permanent magnet 90 achieves the effect of magnetic blowing to extinguish the arc.

In this structure, the permanent magnet 90 is arranged at a side of the arc resistant end contact set 701 so that the permanent magnet is located at the periphery of the arc resistant end contact set 701, as shown in FIG. 17 and FIG. 18. In other embodiments, the permanent magnet 90 can also be set to be replaced with two permanent magnet sets having opposite polarities at their inner ends.

Referring to FIG. 17 to FIG. 24, the arc extinguishing grid 100 includes a grid base 110, one or more arc extinguishing grid pieces 120 and an arc striking grid piece 130. A quantity of the arc extinguishing grid pieces 120 is two or more, and the arc extinguishing grid pieces 120 have equal lengths and aligned ends. The grid base 110 is provided with a plurality of slots 111 parallel to each other, and the arc extinguishing grid pieces 120 and the arc striking grid pieces 130 are inserted into the slots 111, so that each of the arc extinguishing grid pieces 120 and each of the arc striking grid pieces 130 are arranged parallel to each other. In this embodiment, the quantity of the arc extinguishing grid pieces 120 is two. The two arc extinguishing grid pieces 120 have equal lengths and aligned ends, an end of each of the arc extinguishing grid pieces 120 is provided with an arc extinguishing notch 121, and the arc extinguishing notch 121 is V-shaped, so that the end of the arc extinguishing grid piece 120 is of a bifurcated structure. The arc extinguishing notch 121 can be used for facilitating rapid cutting and segmentation of the arc by a pair of arc extinguishing grid pieces 120 through the arc extinguishing notches 121. The arc striking grid pieces 130 are metal grid pieces made of an arc striking magnetic material, and an end of the arc striking grid piece 130 is provided with an arc striking flap piece 131 which exceeds ends of the pair of arc extinguishing grid pieces 120 and bends obliquely to a direction of the contact sets. In this way, the arc can be introduced into the arc extinguishing grid 100 by using the arc striking flap piece 131 on the arc striking grid piece 130, and then with the pair of arc extinguishing grid pieces 120, the arc can be cut into a plurality of small segments, that is, the arc is divided into a plurality of short arcs, thereby greatly increasing the voltage drop of the whole arc.

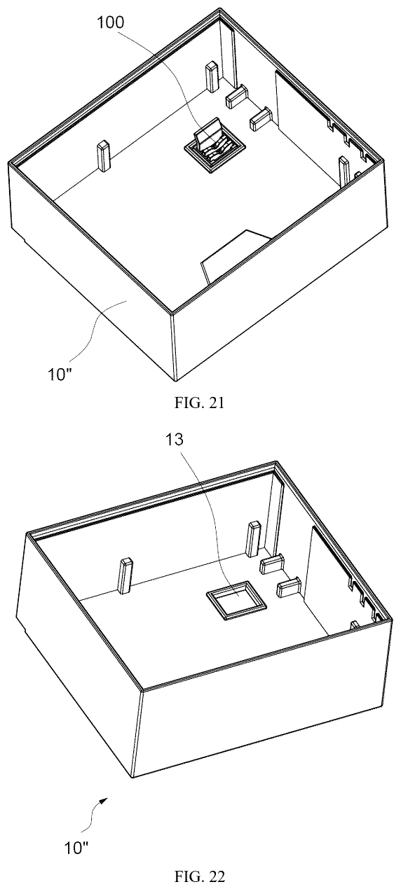

As shown in FIG. 21 to FIG. 24, a base 20″ and a case 10″ are respectively provided with a lower arc extinguishing grid slot 25 and an upper arc extinguishing grid slot 13. The arc extinguishing grids 100 can be respectively mounted in the lower arc extinguishing grid slot 25 and the upper arc extinguishing grid slot 13, so that the arc extinguishing grids 100 are mounted on the base 20″ or the case 10″, and the arc extinguishing grids 100 are located above and below the arc resistant end contact set 701, that is, the contact set consisting of the first movable contact 78 and the second stationary contact 77.

As shown in FIG. 3 and FIG. 4, the first lead-out piece 71 and the second lead-out piece 72 are fixedly mounted on the base 20, and the first movable spring 73 and the second movable spring 74 are arranged on the base 20 in parallel. Moreover, the first lead-out piece 71 and the second lead-out piece 72 are respectively connected to the first lead-out pin 30 and the second lead-out pin 40. Optionally, the first lead-out piece 71 and the second lead-out piece 72 can be integrally molded with the first lead-out pin 30 and the second lead-out pin 40 respectively.

As shown in FIG. 2 to FIG. 4, the first movable spring 73 and the second movable spring 74 are arranged in the first mounting groove 220 in parallel and located at one side in the first mounting groove 220 away from the second mounting groove 230, and the first movable spring 73 and the second movable spring 74 form a parallel movable spring assembly. The first lead-out piece 71 is fixedly connected to an end of the first movable spring 73, the second lead-out piece 72 is fixedly connected to an end of the second movable spring 74, and the first lead-out piece 71 and the second lead-out piece 72 are respectively located at two different ends of the parallel movable spring assembly.

As shown in FIG. 3, specifically, in this embodiment, the first movable spring 73 is provided with a first fixed end and a first cantilevered end. The first fixed end of the first movable spring 73 is fixedly connected to the first lead-out piece 71, so that the first movable spring 73 presents a cantilevered state. The second movable spring 74 is provided with a second fixed end and a second cantilevered end. The second fixed end of the second movable spring 74 is fixedly connected to the second lead-out piece 72, so that the second movable spring 74 presents a cantilevered state. The first fixed end of the first movable spring 73 is opposite to the second cantilevered end of the second movable spring 74, and the first cantilevered end of the first movable spring 73 is opposite to the second fixed end of the second movable spring 74.

The first stationary contact 75 is arranged at the first fixed end of the first movable spring 73, and the first movable contact 78 is arranged at the first cantilevered end of the first movable spring 73. The second stationary contact 77 is arranged at the second fixed end of the second movable spring 74, and the second movable contact 76 is arranged at the second cantilevered end of the second movable spring 74. The first stationary contact 75 and the second movable contact 76 are arranged opposite to each other, and the first movable contact 78 and the second stationary contact 77 are arranged opposite to each other.

As shown in FIG. 3, the magnetic circuit system 60 includes a coil 61, an armature assembly 62, a first push card 63 and a second push card 64. The armature assembly 62 is rotatably mounted on the base 20, the coil 61 is connected to the coil lead-out pin 50, and the coil lead-out pin 50 passes through a bottom surface of the base 20 to lead out downwards. The coil 61 is transversely mounted in the second mounting groove 230. A permanent magnet is arranged in the middle of the armature assembly 62, and the armature assembly 62 can be actuated by the coil 61 with a variable polarity to rotate on the base 20. The first push card 63 and the second push card 64 are movably mounted on the base 20, and two ends of the armature assembly 62 are respectively connected to an end of the first push card 63 and an end of the second push card 64, so that the rotation of the armature assembly 62 causes the first push card 63 and the second push card 64 to move in opposite directions respectively. The other end of the first push card 63 is connected to the first cantilevered end of the first movable spring 73, and the other end of the second push card 64 is connected to the second cantilevered end of the second movable spring 74, so that the movement of the first push card 63 and the second push card 64 respectively in the opposite directions causes the two sets of movable and stationary contacts, namely the first stationary contact 75 and the second movable contact 76, as well as the first movable contact 78 and the second stationary contact 77, to be closed or open together.

In addition, although the above embodiments are described and illustrated by taking an enhanced arc extinguishing structure applied to the magnetic latching relay as an example, the enhanced arc extinguishing structure can also be applied to other switching devices such as air switches and contactors due to the enhanced arc extinguishing structure has the function of enhancing arc extinguishing.

While the present application has been particularly illustrated and described in conjunction with preferred embodiments, it will be understood by those skilled in the art that various changes can be made to the present application in forms and details without departing from the spirit and scope of the present application as defined by the appended claims.

1. A switching device, comprising a contact system, wherein the contact system comprises two contact sets, wherein the two contact sets comprise an arc resistant end contact set and a current carrying end contact set, and each of the two contact sets comprises at least one pair of movable and stationary contacts; when the contact system is disconnected, a gap between the movable and stationary contacts of the arc resistant end contact set is less than a gap between the movable and stationary contacts of the current carrying end contact set, wherein a periphery of the arc resistant end contact set is provided with a permanent magnet.

2. The switching device according to claim 1, wherein the arc resistant end contact set comprises a first movable contact and a second stationary contact, the current carrying end contact set comprises a first stationary contact and a second movable contact, and the contact system further comprises a first movable spring and a second movable spring, wherein the first stationary contact and the first movable contact are respectively arranged at both ends of the first movable spring in a length direction, the second stationary contact and the second movable contact are respectively arranged at both ends of the second movable spring in a length direction, the first stationary contact and the second movable contact are oppositely arranged, and the first movable contact and the second stationary contact are oppositely arranged.

3. The switching device according to claim 1, wherein the switching device further comprises a base, wherein the contact system is mounted on the base, a direction close to the base is defined as below, a direction away from the base is defined as above, ceramic pieces are further arranged above and below the arc resistant end contact set, and the permanent magnet is arranged at a side of the arc resistant end contact set so that the permanent magnet is located at the periphery of the arc resistant end contact set.

4. The switching device according to claim 2, wherein the switching device further comprises a base, wherein the contact system is mounted on the base, a direction close to the base is defined as below, a direction away from the base is defined as above, ceramic pieces are further arranged above and below the arc resistant end contact set, and the permanent magnet is arranged at a side of the arc resistant end contact set so that the permanent magnet is located at the periphery of the arc resistant end contact set; each of the ceramic pieces comprises a first portion and a second portion connected to each other, the first portion and the second portion are perpendicular to each other, the first portion is sheet-shaped, the second portion is plate-shaped with thin in the middle and thick at both sides, a portion which is thin in the middle is provided with a notch which is arc-shaped, and a diameter of the notch is greater than a diameter of contacts of the arc resistant end contact set, so that after the ceramic pieces are mounted, the second portion is at least partially located between the first movable spring and the second movable spring, and the notch is exactly opposite the contacts and at least partially arranged around the contacts.

5. The switching device according to claim 1, wherein the switching device further comprises a base, wherein the contact system is mounted on the base, a direction close to the base is defined as below, a direction away from the base is defined as above, arc extinguishing grids are further arranged above and below the arc resistant end contact set, and the permanent magnet is arranged at a side of the arc resistant end contact set so that the permanent magnet is located at the periphery of the arc resistant end contact set.

6. The switching device according to claim 5, wherein each of the arc extinguishing grids comprises a grid base, one or more arc extinguishing grid pieces and an arc striking grid piece, wherein the grid base is provided with a plurality of slots parallel to each other, and the arc extinguishing grid pieces and the arc striking grid piece are inserted into the slots, so that each of the arc extinguishing grid pieces and the arc striking grid piece are arranged parallel to each other.

7. The switching device according to claim 6, wherein a quantity of the arc extinguishing grid pieces is two or more, the arc extinguishing grid pieces have equal lengths and aligned ends, an end of the arc extinguishing grid piece is provided with an arc extinguishing notch, and an end of the arc striking grid piece is provided with an arc striking flap piece which exceeds the end of the arc extinguishing grid piece and bends obliquely in a direction to the contact sets.

8. The switching device according to claim 7, wherein the switching device further comprises a case, wherein the arc extinguishing grids arranged above and below the arc resistant end contact set are respectively mounted on the case and the base.

9. The switching device according to claim 1, wherein the switching device further comprises a base, wherein the contact system is mounted on the base, a direction close to the base is defined as below, a direction away from the base is defined as above, the permanent magnet is arranged above the arc resistant end contact set so that the permanent magnet is located at the periphery of the arc resistant end contact set, and ceramic pieces are arranged at least in left and right directions of the arc resistant end contact set.

10. The switching device according to claim 1, wherein the permanent magnet is only arranged at the periphery of the arc resistant end contact set, and not arranged at a periphery of the current carrying end contact set.

11. The switching device according to claim 1, wherein the switching device is a magnetic latching relay.

12. The switching device according to claim 2, wherein the switching device further comprises a base, wherein the contact system is mounted on the base, a direction close to the base is defined as below, a direction away from the base is defined as above, ceramic pieces are further arranged above and below the arc resistant end contact set, and the permanent magnet is arranged at a side of the arc resistant end contact set so that the permanent magnet is located at the periphery of the arc resistant end contact set.

13. The switching device according to claim 2, wherein the switching device further comprises a base, wherein the contact system is mounted on the base, a direction close to the base is defined as below, a direction away from the base is defined as above, arc extinguishing grids are further arranged above and below the arc resistant end contact set, and the permanent magnet is arranged at a side of the arc resistant end contact set so that the permanent magnet is located at the periphery of the arc resistant end contact set.

14. The switching device according to claim 2, wherein the switching device further comprises a base, wherein the contact system is mounted on the base, a direction close to the base is defined as below, a direction away from the base is defined as above, the permanent magnet is arranged above the arc resistant end contact set so that the permanent magnet is located at the periphery of the arc resistant end contact set, and ceramic pieces are arranged at least in left and right directions of the arc resistant end contact set.
